(19) United States
(12) Patent Application Publication
(10) Pub. No.: US 2025/0384184 A1
(43) Pub. Date: Dec. 18, 2025

(54) MULTI-DIMENSIONAL COUPLED DESIGN METHOD FOR THROUGH-FLOW AERODYNAMIC LAYOUT OF GAS TURBINE TRANSITION SECTION-HIGH-PRESSURE COMPRESSOR

(71) Applicant: NO.703 RESEARCH INSTITUTE OF CSSC, Harbin (CN)

(72) Inventors: Qi WANG, Harbin (CN); Feng LIN, Harbin (CN); Wenyan XU, Harbin (CN); Xiying NIU, Harbin (CN); Lu YANG, Harbin (CN); Dong LI, Harbin (CN); Lin FU, Harbin (CN); Dongyan MAO, Harbin (CN); Han LIU, Harbin (CN)

(21) Appl. No.: 19/318,484

(22) Filed: Sep. 4, 2025

Related U.S. Application Data
(63) Continuation of application No. PCT/CN2024/142194, filed on Dec. 25, 2024.

(30) Foreign Application Priority Data
Mar. 4, 2024 (CN) 202410244364.8

(51) Int. Cl. G06F 30/20; F01D 25/00

(52) U.S. Cl. CPC G06F 30/20; F01D 25/00

(57) ABSTRACT

The purpose of the present invention is to provide a multi-dimensional coupled design method for the through-flow aerodynamic layout of a gas turbine transition section-high pressure compressor. In the present invention, the transition section and the high-pressure compressor are regarded as a system for integrated coupled design, and full integration with the upstream transition section is achieved in all dimensions and links of the high-pressure compressor's aerodynamic design. This realizes the integrated and collaborative design of the through-flow layout of the transition section and the high-pressure compressor, enabling the aerodynamic design of the transition section-high pressure compressor system in different dimensions to enter a stage of systematization, parameterization and refinement. It effectively improves the aerodynamic performance of the high-pressure compressor, enhances the accuracy of aerodynamic design, saves a large amount of design iteration time, shortens the design cycle, and is highly suitable for engineering design applications. The present invention is not limited to the high-pressure compressor of gas turbines; it is also applicable to the aerodynamic design process of aero-engine high pressure compressors and various industrial axial compressors with transition through-flow structures.

### TECHNICAL FIELD

The present disclosure relates to a gas turbine design method, and specifically to a compressor design method.

### BACKGROUND

As one of the three core components of a gas turbine, the performance of the compressor directly determines the technical index level of the gas turbine. In the development of a high-performance gas turbine, the aerodynamic design of the compressor is the primary key technology and a narrow bottleneck. In a three-rotor simple-cycle gas turbine, the high-pressure compressor has extremely high aerodynamic design difficulty due to factors such as the complex and changeable incoming flow environment and the significant influence of real structures like the upstream transition section. The aerodynamic design technology for high-pressure compressors with high efficiency and high stability has become a core technical link restricting the gas turbine research and development system.

Due to the inherent characteristics of the overall layout of the three-rotor simple-cycle gas turbine, the structure of the transition section connecting the low-pressure and high-pressure compressors will significantly affect the intake resistance and uniformity of the high-pressure compressor. This directly leads to an increase in the incoming flow resistance of the high-pressure compressor and a decrease in intake uniformity, which rapidly deteriorates the flow capacity and internal flow matching of the high-pressure compressor. Therefore, to develop effective technical means that can improve the aerodynamic performance indicators of high-pressure compressors, it is first necessary to solve the problem of the impact of transition section pressure loss and outlet non-uniformity caused by the overall layout on the flow of the downstream high-pressure compressor. Current aerodynamic design methods for high-pressure compressors basically carry out low-dimensional through-flow design under the condition of uniform incoming flow, without taking the influence of the transition section into account. The publicly available solutions to the transition section problem can be summarized into two main types, but both have obvious shortcomings: (1) optimizing the through-flow of the transition section to minimize its impact. This method can improve the incoming flow conditions of the high-pressure compressor to a certain extent, but it does not incorporate the flow factors of the transition section into the aerodynamic design of the high-pressure compressor. Due to the unavoidable losses and non-uniform flow state of the transition section, the performance of the high-pressure compressor is still affected by the upstream incoming flow; (2) the high-pressure compressor is aerodynamically designed according to uniform incoming flow, and then the internal flow of the high-pressure compressor is iteratively optimized through three-dimensional CFD or experimental testing methods. This method is somewhat helpful for improving the performance of the high-pressure compressor, but it requires a large number of three-dimensional CFD calculations or experimental processes, as well as repeated iterative adjustments with the geometric modeling of the high-pressure compressor, resulting in enormous time and resource consumption. At the same time, the final high-pressure compressor scheme obtained through a large number of geometric modeling adjustments differs greatly from the original design, often leading to a serious deviation of the internal load distribution and flow matching of the high-pressure compressor from the design expectations. It can be seen that the existing methods design and optimize the transition section and the high-pressure compressor as independent objects, lacking a systematic consideration of the overall through-flow layout of the transition section and the high-pressure compressor. As a result, the effect of performance improvement is limited, and the performance level of the high-pressure compressor remains a bottleneck restricting the technical development of current three-rotor gas turbines.

As the technical indicators of gas turbines continue to rise, higher requirements are put forward for the aerodynamic design level of compressors. How to design a transition section-high-pressure compressor through-flow aerodynamic layout with low loss and good adaptability is directly related to the performance level of the entire transition section-high-pressure compressor system. The interaction between the transition section and the high-pressure compressor is complex and highly correlated. Therefore, conducting coupled design of the two as a whole is a reasonable approach to solve the above problems and achieve high performance indicators.

### SUMMARY

The purpose of the present invention is to provide a multi-dimensional coupled design method for the through-flow aerodynamic layout of a gas turbine transition section-high-pressure compressor, which can solve the problem of improving the aerodynamic performance level of the gas turbine transition section-high-pressure compressor system.

The objective of the present invention is achieved as follows:

The present invention provides a multi-dimensional coupled design method for a through-flow aerodynamic layout of a gas turbine transition section-high-pressure compressor, which includes the following steps:
(1) Decomposing design indicators: decomposing the overall performance indicators of the gas turbine for the transition section-high-pressure compressor into the transition section performance indicators and the high-pressure compressor performance indicators;
(2) Transition section through-flow design and optimization: performing the aerodynamic design and optimization of the transition section through-flow according to the transition section performance indicator requirements, which includes endwall flow passage profile design, strut profile design, and three-dimensional CFD calculation and analysis, determining whether the design requirements are met based on the three-dimensional CFD calculation and analysis results, if the design requirements are not met, optimizing the transition section endwall flow passage profile and strut profile according to the calculation results, and obtaining a transition section through-flow aerodynamic design scheme that meets the transition section performance indicator requirements through iterative processes;
(3) Extraction of coupled parameters across different dimensions: based on the transition section through-flow aerodynamic design results of step (2), extracting key coupled design parameters of the transition section-high-pressure compressor across different dimensions, and converting them into parameterized inputs for the multi-dimensional design of an integrated transition section-high-pressure compressor through-flow aerodynamic layout;
(4) Integrated transition section-high-pressure compressor through-flow aerodynamic layout design: performing integrated transition section-high-pressure compressor through-flow aerodynamic layout design according to the high-pressure compressor performance indicator requirements, comprising one-dimensional inverse problem through-flow design, one-dimensional characteristic analysis, S2 inverse problem through-flow design, blade shape design, and three-dimensional CFD calculation and analysis, and based on the three-dimensional CFD calculation and analysis results, determining whether the design requirements are met, if the design requirements are met, a current aerodynamic design scheme is a final design scheme; if the design requirements are not met, optimizing the high-pressure compressor design according to the calculation results, and ultimately obtaining a high-pressure compressor aerodynamic design scheme that meets the performance indicator requirements through iterative processes.

The present invention further includes:

1. Decomposing overall performance indicators of the gas turbine for the transition section-high-pressure compressor into transition section performance indicators and high-pressure compressor performance indicators in step (1) includes based on the gas turbine's requirements for the overall through-flow capacity, pressure rise capability, efficiency, and stable operating range of the transition section-high-pressure compressor, extracting the corrected flow rate and total pressure loss requirements of the transition section through-flow under different incoming Mach numbers as the transition section performance indicators, and extracting the design point corrected flow rate, pressure ratio, efficiency, and surge margin requirements at different speeds of the high-pressure compressor, considering the influence of the transition section, as the high-pressure compressor performance indicators.

2. For the endwall flow passage profile design in step (2), an n-th order Bezier curve is used for a parameterized design of the endwall flow passage of the transition section, and structural dimension constraints of the gas turbine on a low-pressure compressor, the high-pressure compressor and the transition section are taken as boundary conditions of the Bezier curve.

3. For the strut profile design in step (2), a polynomial or multi-circular arc airfoils are used as thickness distribution curves to discretize a cross-sectional profile thickness distribution of the strut, and an axial length of the airfoil, leading edge radius, trailing edge radius, and thickness distribution coefficients are used as variable parameters to achieve parameterized design of the strut profile.

4. For optimization design of the transition section endwall flow passage profile in step (2), a global optimization method combining the design of experiments method and gradient optimization algorithm to optimize the endwall flow passage of the transition section.

5. For optimization design of the strut profile in step (2) uses, a combined optimization strategy of the design of experiments method and multi-island genetic algorithms to optimize the strut profile.

6. Extracting key coupled design parameters of the transition section-high-pressure compressor across different dimensions in step (3) include a one-dimensional coupled parameter, S2 stream surface coupled parameters, and a three-dimensional coupled parameter of the transition section-high-pressure compressor.

7. The one-dimensional coupled parameter is a total pressure recovery coefficient of the transition section.

8. The S2 stream surface coupled parameters are the two-dimensional coordinate values of the transition section flow passage and strut profile.

9. The three-dimensional coupled parameters are three-dimensional computational model of a transition section fluid domain, which includes three-dimensional coordinate values of inner and outer wall flow passages and the strut profile.

10. Converting them into parameterized inputs for the multi-dimensional design of the integrated transition section-high-pressure compressor through-flow aerodynamic layout in step (3) include parameterized inputs for one-dimensional inverse problem through-flow design and one-dimensional characteristic analysis, parameterized inputs for S2 inverse problem through-flow design, and parameterized inputs for three-dimensional CFD calculation and analysis.

11. The parameterized inputs for one-dimensional inverse problem through-flow design and one-dimensional characteristic analysis are achieved by specifying a value of the total pressure recovery coefficient of the transition section.

12. The parameterized inputs for S2 inverse problem through-flow design are achieved by connecting, fitting, and smoothing the meridional through-flow profile of the transition section flow passage with that of the high-pressure compressor body flow passage obtained from one-dimensional inverse problem through-flow design, which are then discretized into the integrated meridional through-flow two-dimensional coordinate values of the transition section-high-pressure compressor, which are required for the S2 inverse problem through-flow design.

13. The parameterized inputs for three-dimensional CFD calculation and analysis are achieved by connecting the three-dimensional computational model of the transition section fluid domain with the three-dimensional computational model of the high-pressure compressor fluid domain according to their actual geometric positions, forming an integrated three-dimensional CFD computational model of the transition section-high-pressure compressor.

14. The S2 inverse problem through-flow design in step (4) includes dividing the integrated meridional through-flow of the transition section-high-pressure compressor into computational stations along the flow direction and radial direction, in both the transition section through-flow and the through-flows of each blade row of the high-pressure compressor, five flow-direction computational stations and twelve radial computational stations are divided, and, a streamline curvature method is used to solve the S2 inverse problem for the integrated through-flow of the transition section-high-pressure compressor.

15. The optimization design of the high-pressure compressor in step (4) includes: in the one-dimensional inverse problem through-flow design, optimizing and adjusting the key parameters of axial velocity, pressure ratio, and reaction degree in a stage-by-stage distribution for the high-pressure compressor; in the S2 inverse problem through-flow design, optimizing and adjusting the key parameters of absolute tangential velocity at the inlet, pressure ratio, and loss coefficient distribution along the radius for each stage of the high-pressure compressor; and in the blade profiling design, performing the inlet and outlet geometric angle matching optimization and end-region three-dimensional design optimization for the blades of each stage of the high-pressure compressor.

The advantages of the present invention lie in:

1. The present invention adopts a systematic thinking to conduct a coupled design of the transition section and the high-pressure compressor as an integrated whole. It incorporates the influencing factors of the transition section into the design process of each dimension of the high-pressure compressor, and fully considers the significant impacts of pressure loss and outlet non-uniformity of the transition section on the high-pressure compressor from the very beginning of the high-pressure compressor design. This can fundamentally solve the aerodynamic design problems of the high-pressure compressor caused by the transition section and improve the performance level of the high-pressure compressor.

2. The present invention innovatively associates the through-flow design of the transition section with the aerodynamic design of the high-pressure compressor completely. It focuses on the main factors affecting the performance of the entire transition section-high-pressure compressor system, not only formulating a low-loss through-flow scheme for the transition section, but also obtaining an aerodynamic scheme for the high-pressure compressor based on the through-flow layout characteristics of the transition section. This enables both the transition section component and the high-pressure compressor component of the gas turbine to maximize their performance, thereby achieving a significant improvement in the overall performance level.

3. The present invention fully explains the coupled design process and the key parameters under each link, and connects the aerodynamic design process of the entire transition section-high-pressure compressor system. Through the method of the present invention, the through-flow loss of the transition section and the through-flow matching of the high-pressure compressor can be finely adjusted, realizing the parameterized and refined coupled aerodynamic design of the transition section-high-pressure compressor system in different dimensions and effectively improving the design accuracy.

4. The present invention fully integrates with the upstream transition section in all dimensions and links of the aerodynamic design of the high-pressure compressor. It fully considers the influencing factors brought by the transition section and parameterizes them from the low-dimensional level. This can effectively reduce the number of iterations in the design and R&D process, maximize the consistency between the high-pressure compressor scheme and the original design, and save optimization time while obtaining a high-performance aerodynamic scheme, thus shortening the R&D cycle.

5. The present invention is not limited to the high-pressure compressor of gas turbines; it is also applicable to the aerodynamic design process of aero-engine high-pressure compressors and various industrial axial compressors with transition through-flow structures.

### BRIEF DESCRIPTION OF THE DRAWINGS

FIG. 1 is a flow chart of the present invention.

### DETAILED DESCRIPTION OF THE EMBODIMENTS

The present invention will be described in more detail below with examples in conjunction with the accompanying drawings.

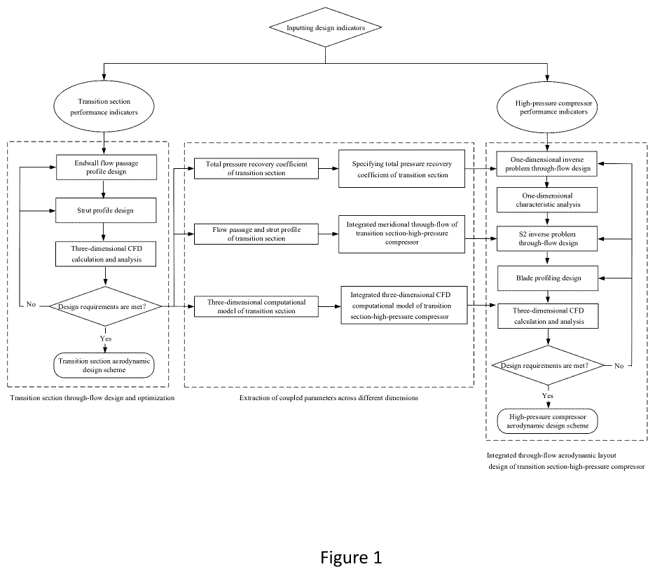

With reference to FIG. 1, the specific implementation method of the multi-dimensional coupled design method for the through-flow aerodynamic layout of a gas turbine transition section-high-pressure compressor in the present invention is realized through the following steps:

Step 1: Decomposing design indicators. Decomposing the overall performance indicators of the gas turbine for the transition section-high-pressure compressor into the transition section performance indicators and the high-pressure compressor performance indicators.

Based on the gas turbine's requirements for the overall through-flow capacity, pressure rise capability, efficiency, and stable operating range of the transition section-high-pressure compressor, extracting the corrected flow rate and total pressure loss requirements of the transition section through-flow under different incoming Mach numbers as the transition section performance indicators, and extracting the design point corrected flow rate, pressure ratio, efficiency, and surge margin requirements at different speeds of the high-pressure compressor, considering the influence of the transition section, as the high-pressure compressor performance indicators.

Step 2: Transition section through-flow design and optimization. The aerodynamic design and optimization of the transition section through-flow are performed according to the transition section performance indicator requirements, which includes endwall flow passage profile design, strut profile design, and three-dimensional CFD calculation and analysis:

The endwall flow passage profile design of transition section adopts an n-th order Bezier curve for a parameterized description, and structural dimension constraints of the gas turbine on a low-pressure compressor, the high-pressure compressor and the transition section are taken as boundary conditions of the Bezier curve to realize the parameterized design of the endwall flow passage profile of the transition section.

The strut profile design of transition section adopts a polynomial or multi-circular arc airfoils as thickness distribution curves to discretize a cross-sectional profile thickness distribution of the strut, and an axial length of the airfoil, leading edge radius, trailing edge radius, and thickness distribution coefficients are used as variable parameters to achieve parameterized design of the strut profile.

It is determined whether the transition section through-flow aerodynamic design scheme meets the design requirements based on the three-dimensional CFD calculation and analysis results, if the design requirements are not met, optimizing the transition section endwall flow passage profile and strut profile according to the calculation results.

In optimization design of the transition section endwall flow passage profile, a global optimization method combining the design of experiments method and gradient optimization algorithm is used to optimize the endwall flow passage of the transition section.

In optimization design of the transition section strut profile, a combined optimization strategy of the design of experiments method and multi-island genetic algorithms is used to optimize the strut profile.

The transition section through-flow aerodynamic design scheme that meets the transition section performance indicator requirements is achieved through iterative processes.

Step 3: Extraction of coupled parameters across different dimensions. Based on the transition section through-flow aerodynamic design results of step 2, the key coupled design parameters of the transition section-high-pressure compressor across different dimensions are extracted, which include a one-dimensional coupled parameter, S2 stream surface coupled parameters, and a three-dimensional coupled parameter of the transition section-high-pressure compressor.

The one-dimensional coupled parameter is a total pressure recovery coefficient of the transition section.

The S2 stream surface coupled parameters are the two-dimensional coordinate values of the transition section flow passage and strut profile.

The three-dimensional coupled parameters are three-dimensional computational model of a transition section fluid domain, which include three-dimensional coordinate values of inner and outer wall flow passages and the strut profile.

The above coupled design parameters are converted into parameterized inputs for the multi-dimensional design of the integrated transition section-high-pressure compressor through-flow aerodynamic layout which include parameterized inputs for one-dimensional inverse problem through-flow design and one-dimensional characteristic analysis, parameterized inputs for S2 inverse problem through-flow design, and parameterized inputs for three-dimensional CFD calculation and analysis.

The parameterized inputs for one-dimensional inverse problem through-flow design and one-dimensional characteristic analysis are achieved by specifying a value of the total pressure recovery coefficient of the transition section.

The parameterized inputs for S2 inverse problem through-flow design are achieved by connecting, fitting, and smoothing the meridional through-flow profile of the transition section flow passage with that of the high-pressure compressor body flow passage obtained from one-dimensional inverse problem through-flow design, which are then discretized into the integrated meridional through-flow two-dimensional coordinate values of the transition section-high-pressure compressor, which are required for the S2 inverse problem through-flow design.

The parameterized inputs for three-dimensional CFD calculation and analysis are achieved by connecting the three-dimensional computational model of the transition section fluid domain with the three-dimensional computational model of the high-pressure compressor fluid domain according to their actual geometric positions, forming an integrated three-dimensional CFD computational model of the transition section-high-pressure compressor.

Step 4: Integrated transition section-high-pressure compressor through-flow aerodynamic layout design. The integrated transition section-high-pressure compressor through-flow aerodynamic layout design is performed according to the high-pressure compressor performance indicator requirements, which include one-dimensional inverse problem through-flow design, one-dimensional characteristic analysis, S2 inverse problem through-flow design, blade shape design, and three-dimensional CFD calculation and analysis. In the S2 inverse problem through-flow design, the integrated meridional through-flow of the transition section-high-pressure compressor is divided into computational stations along the flow direction and radial direction, in both the transition section through-flow and the through-flows of each blade row of the high-pressure compressor, five flow-direction computational stations and twelve radial computational stations are divided, and a streamline curvature method is used to solve the S2 inverse problem for the integrated through-flow of the transition section-high-pressure compressor.

It is determined whether the current design scheme meets the design requirements based on the three-dimensional CFD calculation and analysis results, if the design requirements are not met, the current aerodynamic design scheme is considered as a final design scheme; if the design requirements are not met, the high-pressure compressor design is optimized according to the calculation results, which includes: in the one-dimensional inverse problem through-flow design, optimizing and adjusting the key parameters of axial velocity, pressure ratio, and reaction degree in a stage-by-stage distribution for the high-pressure compressor; in the S2 inverse problem through-flow design, optimizing and adjusting the key parameters of absolute tangential velocity at the inlet, pressure ratio, and loss coefficient distribution along the radius for each stage of the high-pressure compressor; and in the blade profiling design, performing the inlet and outlet geometric angle matching optimization and end-region three-dimensional design optimization for the blades of each stage of the high-pressure compressor. a high-pressure compressor aerodynamic design scheme that meets the performance indicator requirements is ultimately obtained through iterative processes.

The method proposed in the present invention has universality. It is not limited to the high-pressure compressor of gas turbines, but also applicable to the aerodynamic design process of aero-engine high-pressure compressors and various industrial axial compressors with transition through-flow structures.

1. A multi-dimensional coupled design method for a through-flow aerodynamic layout of a gas turbine transition section-high-pressure compressor, characterized in that, comprising:
(1) decomposing design indicators: decomposing overall performance indicators of the gas turbine for the transition section-high-pressure compressor into transition section performance indicators and high-pressure compressor performance indicators;
(2) transition section through-flow design and optimization: performing aerodynamic design and optimization of the transition section through-flow according to the transition section performance indicator requirements, which comprises endwall flow passage profile design, strut profile design, and three-dimensional CFD calculation and analysis, determining whether the design requirements are met based on the three-dimensional CFD calculation and analysis results, if the design requirements are not met, optimizing the transition section endwall flow passage profile and strut profile according to the calculation results, and obtaining a transition section through-flow aerodynamic design scheme that meets the transition section performance indicator requirements through iterative processes;
(3) extraction of coupled parameters across different dimensions: based on the transition section through-flow aerodynamic design results of step (2), extracting key coupled design parameters of the transition section-high-pressure compressor across different dimensions, and converting them into parameterized inputs for the multi-dimensional design of an integrated transition section-high-pressure compressor through-flow aerodynamic layout;
extracting key coupled design parameters of the transition section-high-pressure compressor across different dimensions which comprise a one-dimensional coupled parameter, S2 stream surface coupled parameters, and a three-dimensional coupled parameter of the transition section-high-pressure compressor;
converting them into parameterized inputs for the multi-dimensional design of the integrated transition section-high-pressure compressor through-flow aerodynamic layout which comprise parameterized inputs for one-dimensional inverse problem through-flow design and one-dimensional characteristic analysis, parameterized inputs for S2 inverse problem through-flow design, and parameterized inputs for three-dimensional CFD calculation and analysis;
(4) integrated transition section-high-pressure compressor through-flow aerodynamic layout design: performing integrated transition section-high-pressure compressor through-flow aerodynamic layout design according to the high-pressure compressor performance indicator requirements, comprising one-dimensional inverse problem through-flow design, one-dimensional characteristic analysis, S2 inverse problem through-flow design, blade shape design, and three-dimensional CFD calculation and analysis, and based on the three-dimensional CFD calculation and analysis results, determining whether the design requirements are met, if the design requirements are met, a current aerodynamic design scheme is a final design scheme; if the design requirements are not met, optimizing the high-pressure compressor design according to the calculation results, and ultimately obtaining a high-pressure compressor aerodynamic design scheme that meets the performance indicator requirements through iterative processes.

2. The multi-dimensional coupled design method for the through-flow aerodynamic layout of the gas turbine transition section-high-pressure compressor according to claim 1, characterized in that, decomposing overall performance indicators of the gas turbine for the transition section-high-pressure compressor into transition section performance indicators and high-pressure compressor performance indicators in step (1) comprises based on the gas turbine's requirements for the overall through-flow capacity, pressure rise capability, efficiency, and stable operating range of the transition section-high-pressure compressor, extracting the corrected flow rate and total pressure loss requirements of the transition section through-flow under different incoming Mach numbers as the transition section performance indicators, and extracting the design point corrected flow rate, pressure ratio, efficiency, and surge margin requirements at different speeds of the high-pressure compressor, considering the influence of the transition section, as the high-pressure compressor performance indicators.

3. The multi-dimensional coupled design method for the through-flow aerodynamic layout of the gas turbine transition section-high-pressure compressor according to claim 1, characterized in that, for the endwall flow passage profile design in step (2), an n-th order Bezier curve is used for a parameterized design of the endwall flow passage of the transition section, and structural dimension constraints of the gas turbine on a low-pressure compressor, the high-pressure compressor and the transition section are taken as boundary conditions of the Bezier curve.

4. The multi-dimensional coupled design method for the through-flow aerodynamic layout of the gas turbine transition section-high-pressure compressor according to claim 1, characterized in that, for the strut profile design in step (2), a polynomial or multi-circular arc airfoils are used as thickness distribution curves to discretize a cross-sectional profile thickness distribution of the strut, and an axial length of the airfoil, leading edge radius, trailing edge radius, and thickness distribution coefficients are used as variable parameters to achieve parameterized design of the strut profile.

5. The multi-dimensional coupled design method for the through-flow aerodynamic layout of the gas turbine transition section-high-pressure compressor according to claim 1, characterized in that, for optimization design of the transition section endwall flow passage profile in step (2), a global optimization method combining the design of experiments method and gradient optimization algorithm to optimize the endwall flow passage of the transition section.

6. The multi-dimensional coupled design method for the through-flow aerodynamic layout of the gas turbine transition section-high-pressure compressor according to claim 1, characterized in that, for optimization design of the strut profile in step (2) uses, a combined optimization strategy of the design of experiments method and multi-island genetic algorithms to optimize the strut profile.

7. The multi-dimensional coupled design method for the through-flow aerodynamic layout of the gas turbine transition section-high-pressure compressor according to claim 1, characterized in that, the one-dimensional coupled parameter is a total pressure recovery coefficient of the transition section.

8. The multi-dimensional coupled design method for the through-flow aerodynamic layout of the gas turbine transition section-high-pressure compressor according to claim 1, characterized in that, the S2 stream surface coupled parameters are the two-dimensional coordinate values of the transition section flow passage and strut profile.

9. The multi-dimensional coupled design method for the through-flow aerodynamic layout of the gas turbine transition section-high-pressure compressor according to claim 1, characterized in that, the three-dimensional coupled parameters are three-dimensional computational model of a transition section fluid domain, which comprises three-dimensional coordinate values of inner and outer wall flow passages and the strut profile.

10. The multi-dimensional coupled design method for the through-flow aerodynamic layout of the gas turbine transition section-high-pressure compressor according to claim 1, characterized in that, the parameterized inputs for one-dimensional inverse problem through-flow design and one-dimensional characteristic analysis are achieved by specifying a value of the total pressure recovery coefficient of the transition section.

11. The multi-dimensional coupled design method for the through-flow aerodynamic layout of the gas turbine transition section-high-pressure compressor according to claim 1, characterized in that, the parameterized inputs for S2 inverse problem through-flow design are achieved by connecting, fitting, and smoothing the meridional through-flow profile of the transition section flow passage with that of the high-pressure compressor body flow passage obtained from one-dimensional inverse problem through-flow design, which are then discretized into the integrated meridional through-flow two-dimensional coordinate values of the transition section-high-pressure compressor, which are required for the S2 inverse problem through-flow design.

12. The multi-dimensional coupled design method for the through-flow aerodynamic layout of the gas turbine transition section-high-pressure compressor according to claim 1, characterized in that, the parameterized inputs for three-dimensional CFD calculation and analysis are achieved by connecting the three-dimensional computational model of the transition section fluid domain with the three-dimensional computational model of the high-pressure compressor fluid domain according to their actual geometric positions, forming an integrated three-dimensional CFD computational model of the transition section-high-pressure compressor.

13. The multi-dimensional coupled design method for the through-flow aerodynamic layout of the gas turbine transition section-high-pressure compressor according to claim 1, characterized in that, the S2 inverse problem through-flow design in step (4) comprises dividing the integrated meridional through-flow of the transition section-high-pressure compressor into computational stations along the flow direction and radial direction, in both the transition section through-flow and the through-flows of each blade row of the high-pressure compressor, five flow-direction computational stations and twelve radial computational stations are divided, and a streamline curvature method is used to solve the S2 inverse problem for the integrated through-flow of the transition section-high-pressure compressor.

14. The multi-dimensional coupled design method for the through-flow aerodynamic layout of the gas turbine transition section-high-pressure compressor according to claim 1, characterized in that, the optimization design of the high-pressure compressor in step (4) comprises: in the one-dimensional inverse problem through-flow design, optimizing and adjusting the key parameters of axial velocity, pressure ratio, and reaction degree in a stage-by-stage distribution for the high-pressure compressor; in the S2 inverse problem through-flow design, optimizing and adjusting the key parameters of absolute tangential velocity at the inlet, pressure ratio, and loss coefficient distribution along the radius for each stage of the high-pressure compressor; and in the blade profiling design, performing the inlet and outlet geometric angle matching optimization and end-region three-dimensional design optimization for the blades of each stage of the high-pressure compressor.
